(19) United States
(12) Patent Application Publication
(10) Pub. No.: US 2005/0024221 A1
(43) Pub. Date: Feb. 3, 2005

(54) Self-contained alert device

(76) Inventors: Pamela Jamison-Lenz, Lino Lakes, MN (US); James Reede Gray, Roseville, MN (US)

Correspondence Address: Roger W .Jensen;Roger W. Jensen & Associates, Ltd., 8127 Pennsylvania Circle, Minneapolis, MN, 55438, US

(21) Appl. No.: 10/633,077

(22) Filed: Aug. 2, 2003

(51) Int. Cl. G08B 21/00

(52) U.S. Cl. 340/686.1; 340/568.1

(57) ABSTRACT

A self-contained alert device for selective insertion between two adjacent and relatively movable separable parts of a closure. The device is passive when constrained by the closure but, when removed from the closure and therefore unconstrained, the device automatically energizes integral means for activating integral signal emitting means either locally or remotely or both locally and remotely. The device comprises in part a card-like member having at least two hinged flaps selectively foldable from an open to a closed position; integral spring means biasing the flaps apart; and integral switching means, signal emitting means, and power supply means.

### BACKGROUND AND BRIEF SUMMARY OF THE INVENTION

This invention provides a very specialized family of alarms.

The “alarm” field may be broadly defined as a means, i.e., devices and/or systems, for activating an audible and/or visual signal emitting device and/or other display means upon the occurrence of some event, e.g., an intruder into a room, building, or other space; a thief taking a valuable item; or a security threat to a person; etc. The need for intrusion detection, anti-theft and personal security devices and systems is significant, has been recognized for many years, and the need is growing. Accordingly the prior art contains numerous patents showing a wide variety of alarm means and applications.

The present invention is clearly distinguishable over the prior art devices and systems. Our invention provides a unique self-contained alert device which, in some embodiments, provides a signal emitting means having a loud audible “local” signal or alarm. In an alternate embodiment, the device is locally silent, but uses wireless technology to activate remote alarm means. Another embodiment-provides for both local and remote alarm actuation. It should also be understood that the signal emitting means may comprise, at least in part, a visual indicating means such as a light or display means. The present invention also may be used for non-alarm type applications as will be discussed below.

The self-contained alert device comprises a card-like member having at least two hinged flaps which are foldable about a hinge axis onto each other from an open position to a closed or abutted position.

The self-contained alert device is available for a plurality of uses by the closed card-like member being selectively inserted by the user between two adjacent, relatively movable, separable parts or elements of a closure.

The term “closure” is intended to generically cover a very broad range of means, each of which has two parts or elements which are relatively movable. Examples of closures include, but are not limited to, (a) a window movable either vertically or horizontally or pivoted with respect to a window frame or jamb; (b) a door rotatably hinged, or slidable, with respect to a door frame or jamb; (c) an envelope having two opposed sides or elements with an opening for receiving an article; (d) an object, e.g., a valuable vase, resting on a support means; (e) a waistband of a garment and the waist of the person wearing the garment; and (f) a finger(s) of a human co-acting with another finger or other part of the human hand.

The term “self-contained” is a very important and distinguishing feature of my invention. The self-contained alert device may be (and typically would advantageously usually be) relatively small in size but would, nevertheless, include an integral power supply means, which, in circuit with integral (a) switching means and (b) signal emitting means, would function to automatically activate the signal emitting means upon the flaps opening from the closed position to an open position. The self-contained alert device includes spring means connected to the flaps which function to automatically open the flaps as soon as the closed card-like member is free of the restraint of the closure. The switching means is inoperative when the flaps are closed but becomes operative, when the flaps are open, to activate the signal emitting means.

To use the self-contained alert device, the user simply inserts the closed card-like member into the closure to be monitored; the card-like member will be passive until there is movement between the relatively movable parts or elements of the closure, e.g., the doors depicted in FIGS. 7 and 20A are opened from the depicted closed position; this will release the constraint of the closure on the card-like member so that it will automatically open up as aforesaid to thus automatically activate the signal emitting means, i.e., local and/or remote alarm and/or display means.

The self-contained alert device may also be utilized in a “lighter” context, examples being a child's toy, a refrigerator door actuation of a “warning, or the like” to a dieting person, etc.

### DESCRIPTION OF THE DRAWINGS

FIG. 1 is a perspective view of one embodiment of a self-contained alert device of the invention comprising, in part, a card-like device having two hinged flaps which are foldable onto each other from an open position (as shown in FIG. 1) to a closed or abutted position (as shown in FIG. 3A);

FIG. 2 is a cross-sectional side view of the device shown in FIG. 1 as viewed along section lines 2-2 thereof with the flaps shown in the closed position but also, in dotted lines, flap 12 is shown in the open position;

FIG. 2A is a partial, side view of a modification of the device shown in FIGS. 1 and 2 which show an alternate method of connecting spring means to the flaps;

FIG. 3 is a cross-sectional front view of the device of FIG. 1 with the flaps in open position as viewed along section lines 3-3 of FIG. 1;

FIG. 3A is a cross-sectional front view of the device of FIG. 1 with the flaps in closed or abutted position as viewed along section lines 3-3 of FIG. 1;

FIG. 3B is an enlarged view of a portion of FIG. 3A with the addition of an optional means for selectively temporarily disabling the alarm function of the self-contained alert device;

FIG. 4 is a simplified schematic wiring diagram for the self-contained alert device shown in FIG. 1 with “local” signal emitting means;

FIG. 5 is a simplified block diagram of an alternate embodiment of the invention where activation of the switch means by the opening of the flaps of the self-contained alert card does not activate a “local” signal emitting means, but, using wireless technology, activates a “remote” signal emitting means;

FIG. 5A is an expanded block diagram of one embodiment of the invention using wireless technology to couple the output signal of the self-contained alert card to a remote signal emitting system;

FIG. 5B is a simplified block diagram of another embodiment of the invention comprising, in part, a self-contained alert device having both “local” and “remote” signal emitting means;

FIGS. 6 to 13 respectively depict representative examples of uses of the invention, i.e., the card-like member of the self-contained alert device having been selectively inserted by the user into a plurality of “closures” as follows:

FIG. 6 depicts the card-like member inserted into a closure, i.e., the gap between a window and its window frame or sill;

FIG. 7 depicts the card-like member selectively inserted into a gap between a door and its door frame or jamb, as shown the insertion is well above the door handle but could be made anywhere along the gap;

FIG. 8 depicts the card-like member inserted into a closure defined by the waistband of a garment, e.g., walking or running shorts, and the waist of the human wearing the garment;

FIG. 9 depicts the card-like member inserted between and held by the fingers of a human;

FIG. 10 depicts the card-like member held by the fingers of a child for a “toy” mode of use;

FIG. 11 depicts the card-like member inserted into a closure between two adjacent and opposed sides or elements of an envelope;

FIG. 12 depicts the card-like member inserted between the bottom of a vase and the support means, e.g., table, for the vase;

FIG. 13 depicts the card-like member inserted into a closure in the form of a pocket of a carrying case (a form of an envelope) having two adjacent and opposed sides or elements;

FIG. 14 depicts another embodiment of the invention comprising a three flap or element card-like member having a first or main element and two additional elements hinged to the main element and foldable thereupon;

FIG. 15 shows a plan view of the card-like member of FIG. 14 after being cut but before the folding of the flaps;

FIG. 16 shows a card-like element with an alternate (capacitance type) switching means;

FIG. 17 is a block diagram of a circuit for processing the signal from the capacitance type switching means shown in FIG. 16;

FIG. 18 is a block diagram of an audio record and playback system which may be used with, as part thereof, the self-contained alert device for selectively and repetitively recording customized messages or other signals for the signal emitting means;

FIG. 19 is a perspective view of another embodiment of a self-contained alert device comprising, in part, a card-like member;

FIG. 20 is a cross-sectional view of the card-like member of FIG. 19 as viewed along section lines 20-20 thereof;

FIG. 20A is similar to FIG. 20 except the flap 242 is shown in the “open circuit” position corresponding to the card like member being inserted into and constrained by a closure; and

FIG. 21 is a front elevational view of the device of FIG. 19 as viewed along the section lines 21-21 of FIG. 20A.

### DETAILED DESCRIPTION OF THE INVENTION

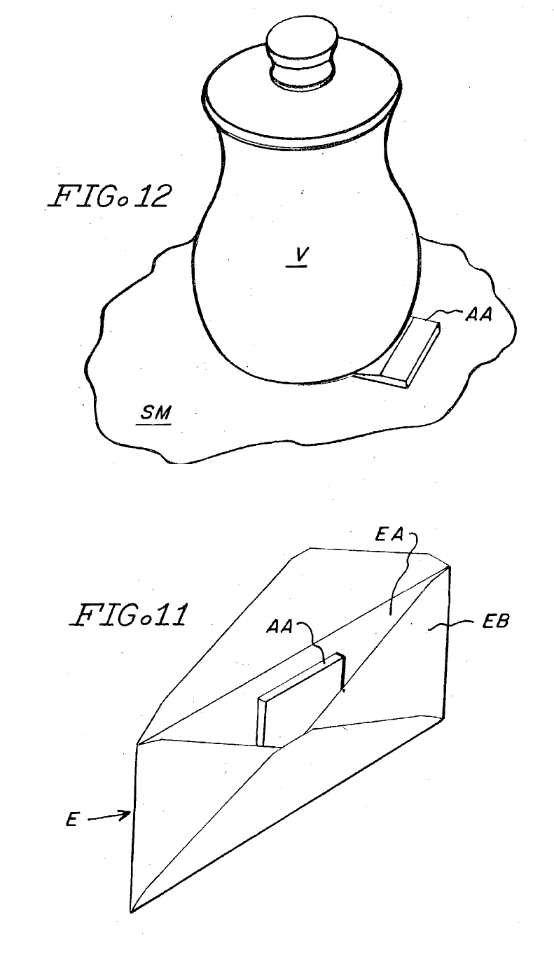

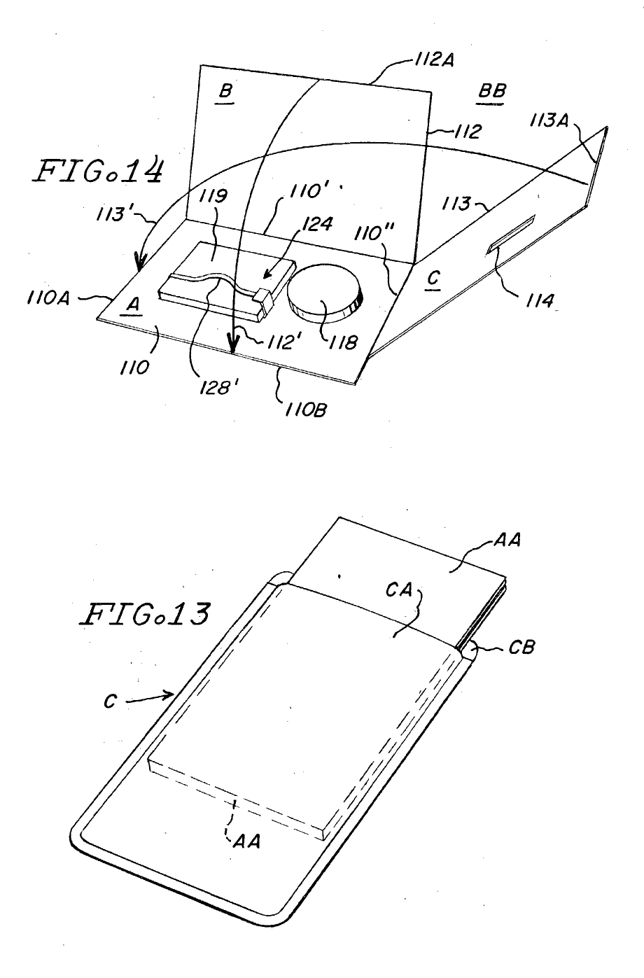

Referring to FIGS. 1, 2, 3 and 3A, the designator AA identifies a self-contained alert device for selective insertion between two adjacent and relatively movable separable parts of a closure, examples of which are depicted in FIGS. 6 to 13. For example, a door D is shown in FIG. 7 in closed position with respect to a doorjamb or frame DF. The vertically extending edge of door D and the adjacent vertically extending surface of the doorframe DF constitute a “closure” or gap into which a user may selectively insert the self-contained alert device AA. Upon the beginning of the opening of door D, the hinged flaps of the self-contained alert device AA will no longer be held in or constrained to a closed position and, due to the biasing force of the spring means, will automatically start to open to activate the alarm means as will now be explained. For the example of FIG. 7, it would be expected that the device AA, when free of restraint by the closure, would start falling toward the floor. The signal emitting means would function, as indicated, as soon as the flaps started to open up and would continue after the device AA lay on the floor.

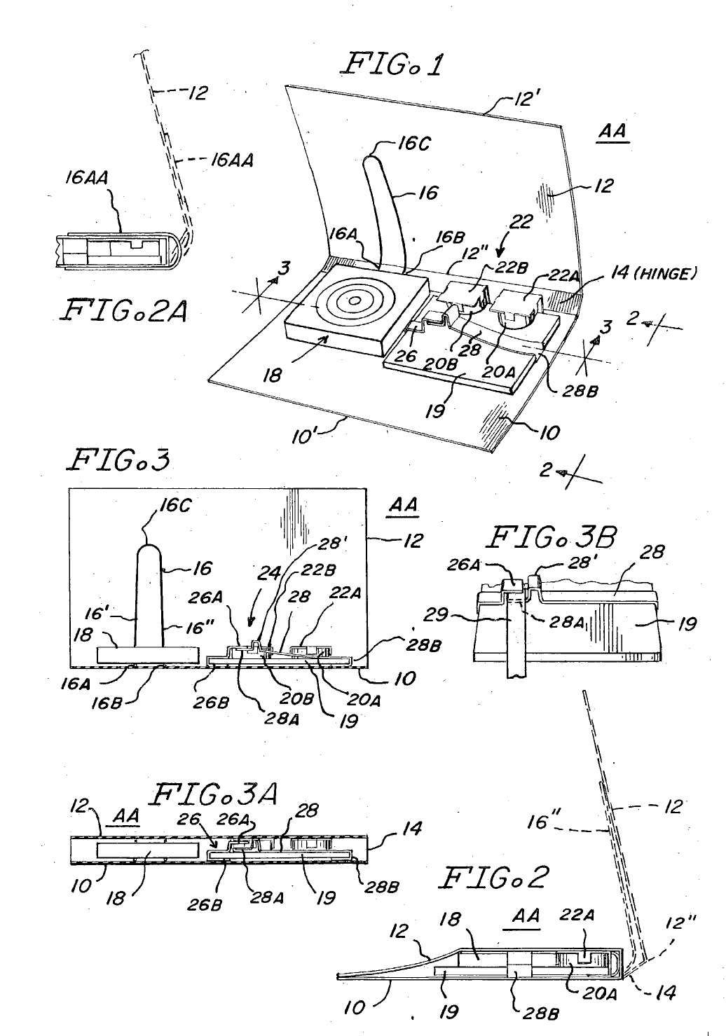

The self-contained alert device AA comprises a card-like member having at least two flaps 10 and 12 hinged together with hinge means 14 which facilitates the flaps to be either in an open position shown in FIGS. 1, 2(flap 12 shown by dotted line), and 3 or in a closed position shown in FIGS. 2(flap 12 shown by solid line) and 3A. The flaps 10 and 12, together with the hinge means 14, may be a unitary member die cut from paper stock. As shown in FIG. 1, the hinge means is defined by a crease 12″ which is parallel to and spaced from the longitudinal edges 12′ of flap 12 and 10′ of flap 10 respectively. In one embodiment the basic card, i.e., the flaps 10 and 12 are die cut as a single rectangularly shaped sheet from 80# weight card stock and with both sides of the sheet being laminated. The laminate provides an integral spring-like characteristic so that, after the aforesaid sheet is die cut, and folded along a fold line to define two flaps foldable onto each other, the inherent, integral spring function of the laminated card stock will bias the flaps away from a “closed” position toward an “open” position.

While the two flaps may be integral as above described, it should be understood that each flap may be separate and discrete and possibly optionally dissimilar. In all cases, the flaps would be connected by appropriate hinge means so that the flaps may be selectively folded toward or onto each other from an open position to a closed position. An example of dissimilar flaps would be to have a first flap of stiff thin plastic of about the size and thickness of a standard credit card hinged to a second flap of 80# weight card stock and of approximately the same dimensions. A different example of dissimilar materials for the flaps would be to have one flap of plastic material and the other flap of spring material; for this embodiment, the flap of spring material would have a dual function of the flap and the biasing spring means.

Further, the scope of this invention includes the flaps having different longitudinal widths, i.e., the portions of the flaps to be inserted into the-closure need not be limited to each flap having the same longitudinal width (see longitudinal edges 10′ and 12′ of alert card AA in FIG. 1). The above example of a flap of spring metal is a likely example of the flaps having different longitudinal widths.

The dimensions of the alert card are not critical. However, the card can be relatively small in size which has a number or operational and economic advantages; an alert card having the dimensions of 2″×3½″×3/16″ has been found to be quite satisfactory but it should be understood that the alert cards could be smaller or larger.

The above-described spring function of the laminated paper stock is one of the preferred spring means connected to or associated with the flaps for causing the flaps to open from a closed position to an open position. However, it should be understood that the invention encompasses other means for achieving that function. An example is the spring means 16 depicted in FIGS. 1 to 3. Spring means 16 has a U-shape with elongated legs 16′ and 16″ (see FIG. 3) extending from a bight portion 16C; the bight 16C and legs 16′ and 16″ are shown in abutting relationship with the inside of flap 12. The extremities of the legs 16′ and 16″ are 16A and 16B respectively; the lengths of the legs are preselected so that they extend past the hinge means 14 and into contact with the flap 10 to which they are bonded or attached by suitable means and also are positioned between the signal emitter means 18 as is shown in FIGS. 3 and 3A. It will be understood that the function of the spring means is to provide a spring bias to open up the flaps when the flaps are not constrained. Thus, as shown in FIG. 1, the flaps 10 and 12 are open and the spring means 16 is in a relaxed state. When the flaps are manually controlled or compressed into a closed condition as shown in FIGS. 2 and 3A, then the spring means 16 is stressed or active to try to bias the flaps apart.

Another means to provide the spring function is shown in the modified structure of FIG. 2A which is similar to that of FIG. 2 but shows a spring means 16AA, similar to the spring means 16 of FIG. 2, but positioned on the outside of the flaps 10 and 12. The spring means 16AA, as is the case of spring means 16, functions to bias the flaps to the open position.

Also it should be understood that the term “spring means” is intended to include metal and other materials such as certain plastics which have spring characteristics. For example, a unitary elongated strip of plastic could have a centrally located fold or hinge means; the plastic material on either side of the bend would be the “flaps”; and the plastic material per se would be the spring means tending to bias the flaps apart.

The signal emitter means 18 shown is also representative of a number of means that may be used within the scope of this invention. The typical and usual function of the signal emitter means is to provide a preselected audible signal when energized or activated which occurs when the flaps open sufficiently from a closed position due to the biasing force of the spring means so that the switch means is actuated to in turn actuate the signal emitter means. A representative example of a signal emitter means 18 is a commercially available miniature audio speaker well known to those skilled in the art.

One of the important features of this invention is that the actual audio output from the signal emitter can be tailored to the specific application. For example, the audio output of the signal emitter may be either a steady state or an intermittent, relatively high frequency screech in the normal audible range. One alternate would be to have the output frequency preselected to be above the normal human audible range. Further, as discussed in detail below, the local alert card may be entirely silent; for this case, the alert card will actuate a remote signal emitting means through the use of wireless technology.

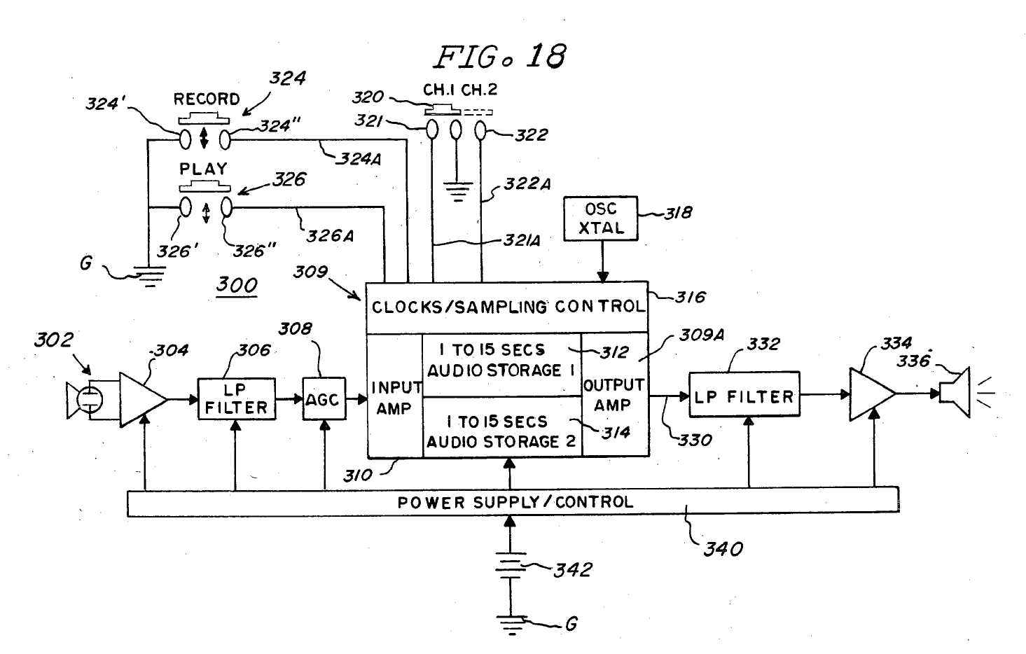

Further, the audio output may be a pre-recorded “voice-type” audio message using well-developed commercially available integrated circuit chip technology well known to those skilled in the art. My invention further includes an arrangement shown in FIG. 18 which provides for customizing the audio message as will be discussed in detail below.

The activation or energization of the signal emitter means 18, upon the opening of the flaps from a closed position is controlled by a switch means 24 which, when closed, completes a simple series electrical circuit comprising a power supply means 22, the signal emitter means 18 and the switch means 24 as is schematically shown in FIG. 4, connection means 30A, 30B and 30C providing the electrical connections as shown.

The switch means 24 has two states or conditions, i.e., open or closed circuit; it comprises two separate, co-acting elements 26 and 28 each being elongated strips of conductive material. The strips 26 and 28 are secured in aligned longitudinal orientation as is clearly shown and are held as shown by first ends 26B and 28B thereof being respectively secured to the underside of a circuit card 19, a thin, square shaped device attached by means not shown to the side of flap 10 visible in FIG. 1, the positioning of ends 26B and 28B being clearly shown in FIGS. 3 and 3A. The other ends 26A and 28A of the conductive strips 26 and 28 are sized and configured so that, when the flaps are open, the top of end 28A is in electrical contact with the bottom or undersurface of end 26A; the aforesaid electrical contact being facilitated by the strip 28 having a spring-like characteristic which biases the strip 28 to the position shown in FIG. 3 whereat, as stated, an electrical contact is established with the strip 26. At this point, the switch means has a “closed” state, which is its state as long as the alert card flaps are in the open position.

The means for changing switch means 24 from “closed” to “open” includes a raised or upwardly extending tab 28′ integral with strip 28 as is best shown in FIG. 3B. The vertical height of tab 28′ is preselected so that it will abut the surface of flap 12 visible in FIG. 1 somewhat before the flaps are in the full closed position shown in FIG. 3A; then, as the flaps are fully closed, the tab 28′ and the entire strip 28 will be pressed downwardly as shown in FIG. 3A so as to open up, i.e., disconnect the electrical contact between the aforesaid ends 26A and 28A.

Obviously, the reverse sequence occuts when the flaps change from a closed position or condition (the alert card being constrained by a closure) to an open position or condition, i.e., the ends 26A and 28A change from being (a) out of contact to (b) into electrical contact

It will be understood that the switch means 24 is merely representative of a switching function that may be supplied by various means and that the scope of this invention is not limited to the specifics of the depicted switch means 24. For example, FIG. 16 depicts a switch means comprising, in part, a capacitive means having sensing elements on the facing surfaces of the card flaps as will be discussed in more detail below.

The power supply means 22 depicted comprises a commercially available D.C. battery means mounted on the circuit card 19; as shown, the battery means is a pair of cells 20A and 20B mechanically attached to the card 19 by holding clip means 22A and 22B and electrically connected in series to circuit means (not shown) on the underside of circuit card 19, but schematically shown in the simplified circuit diagram of FIG. 4. Those skilled in the art will understand that other configurations and means may be used for providing power supply means integral with the self-contained alert device.

As an interim summary, it is seen from the above description, that this invention provides a self-contained alert device for selective insertion between two adjacent and relatively movable separable parts or elements of a closure and for automatically providing a local signal when removed from the closure so as to provide intrusion detection, personal security, and/or anti-theft functions. FIGS. 6 to 13 respectively show a plurality of different, representative examples of closures into which the self-contained alert device may be inserted by the user of the device.

Optional Disabling Means

An optional feature of my invention is a temporary, selective disabling means depicted in FIG. 3B. An insulative means 29 (shown as a strip of insulative material) may be manually inserted between the opposed ends 26A and 28A of the conductive strips 26 and 28 respectively; this provides a selective means for disabling the self-contained alert device which can be advantageous. For example, the card as shown in FIG. 3 has the flaps open which would result in the switch means contacts 26A and 28A to be in contact but, for various reasons, one might not want the signal emitter means to be activated; the insertion of the insulative means 29 between the ends 26A and 28A would prevent the activation of the signal emitter means. Reasons for the temporary disabling of the alert device include initial shipments from the factory to the consumer and short and long-term storage before active usage. Other means for temporarily disabling the self-contained alert device are within the scope of the invention.

Actuation of (1) a Remote Signal Emitting Means and (2) Combined Local and Remote Signal Emitting Means

As indicated, the self-contained alert device depicted in FIGS. 1 to 3 provide a “local” signal from the signal emitting means, the local signal being highly desirable for many applications.

However, there may be applications where it is preferred that the local signal be silent in favor of a “remote” signal emitting means. An example of this is when there is an unauthorized intrusion of a facility protected by a remotely located security force; a silent warning of such intrusion can advantageously assist the security force.

There also may be applications of the invention where it is desirable to have both a local and a remote signal emitting function. An example of this is when a human (perhaps jogging alone in an unpopulated area) senses a personal threat from a human or animal source; here both a local audible signal is essential for its immediate hoped-for benefit of defusing the threat and simultaneously the remote signal emitting means may be critical in providing the appropriate security response.

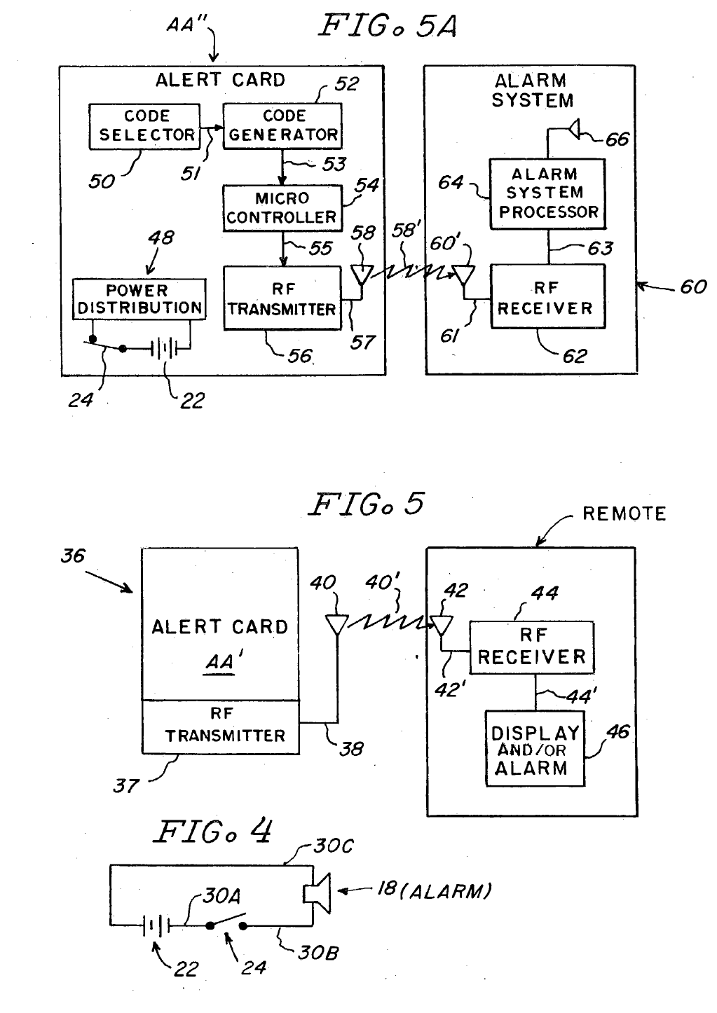

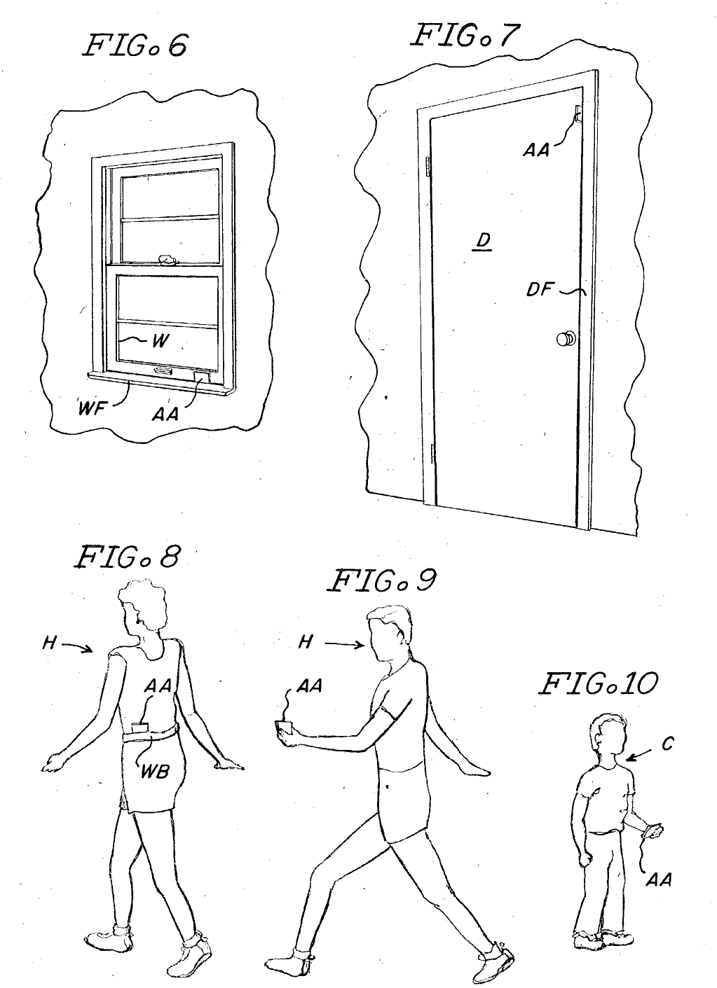

FIGS. 5 and 5A show embodiments of the invention which are representative of applications wherein the activation of the signal emitting means does not produce a “local” audible sound, but instead, using wireless technology, produces at a “remote” location an audible or other signal. FIG. 5B shows an embodiment of the invention where activation of the signal emitting means provides both local audible sound and remote sound and/or display means. The term “remote sound and/or display means” is intended to include a range of apparatus currently used in the security field, e.g., computerized identification systems based upon the characteristics of the incoming signal; direction detection means; etc.

Referring to FIG. 5, a self-contained alert device and system is depicted comprising a card-like device AA′ very similar to the card-like device AA except for (a) the addition of means for producing a wireless, e.g., a RF (radio frequency) signal for transmission to a remote station or means for a signal emitting function, this means being identified in FIG. 5 as RF transmitter means 37, and (b) the deletion (for this embodiment) of the audio sound producing means.

The RF transmitter means 37 is one of the numerous presently commercially available wireless transmitters which are widely used for keyless entry systems for automobiles, remote reading of utility meters, garage door openers, etc. For example, Texas Instruments Inc. has a line of wireless integrated chips which may be used with this invention. This invention requires only a single channel, one-way communication which permits a very small, very simple transmitting means. While amplitude modulation or frequency modulation technology may be utilized, the use of digitally coded signals provides desired security and reliability.

The output from the RF transmitter 37 is coupled via 38 to an antenna means 40 for the wireless transfer 40′ of the signal from device 36 which is received by a suitable remote RF receiver means 44 via an antenna means 42 and connection 42′. The output from the receiver means 44 is coupled via 44′ to a display and/or alarm means 46. The term “display and/or alarm means” is intended to broadly include a wide range of apparatus and systems currently used in the security field for responding to a remote “alert signal.” Examples would include the sophisticated means used at a central “station” for a plurality of remotely dispersed building security (entry, fire, etc), as well as very simplistic dedicated alarms or displays which are dedicated to a particular or specific remote user of the self-contained device 36.

The block diagram of FIG. 5A shows an alert card AA″ again similar to alert card AA except for the addition of a digital coded RF wireless transmitting means and the deletion of the local audible alarm.

Alert card AA″ includes a code selector 50 for controlling, via 51, a code generator 52 which functions to provide, via 53, a serial digital bit stream to a micro controller 54, the output of which is a modulation signal for a RF transmitter 56 having a connection 57 to an appropriate antenna means 58. The alert card AA″ also includes a power distribution means 48 connected to the shown components utilizing the power supply means 22. Also shown in FIG. 5A is the switch means 24 of the basic alert card AA.

Thus, when the alert card AA″ is activated, the “local” RF transmitter 56 will operate to supply an alert wireless signal 58′ from antenna means 58 to an appropriate “remote” wireless receiving means 60. The wireless receiving means 60 comprises an antenna means 60′ coupled via 61 to RF receiver means 62 which, in turn, is coupled via 63 to an alarm, i.e., signal emitting system processor 64, a controller for activating either an alarm 66 or a display means similar to means 46 of the apparatus shown in FIG. 5.

As indicated, there are some applications where it is important to have both a local and a remote means for providing an alert signal. Referring to FIG. 5B, a self-contained alert device AA′″ comprises a basic alert card 70 similar to device AA shown in FIG. 1 and including, via connection 71, a local signal emitting means 72. In addition, via connection 73, the alert card 70 can actuate a RF transmitter means 74, the output is applied, via 75, to an antenna means 76. Wireless transmissions 76′ from the antenna means 76 are received by a remote means 80 including antenna means 81 connected, via 82, to a RF receiver means 83 which actuates a signal emitting means 85. Returning to the example of the jogger suddenly faced by a threat, and assuming the jogger was using (see FIG. 8) an alert card of the AA′″ type depicted in FIG. 5B, the jogger could remove the alert card from the depicted closure and allow the flaps of the card to open, e.g., by dropping it on the ground. The alert card will immediately and automatically produce a local, audible sound and simultaneously activate the remote signal emitting means 85.

Alternate Switching Means

As indicated above the switching means 24 shown in FIGS. 1 to 3 is merely representative of the switching function required upon the self-contained alert device being freed of the restraint of a closure so that the flaps may open by the biasing force of the spring means. Other switching means will be contemplated by those skilled in the art and are to be considered to be clearly within the scope of this invention.

One such alternate switching means is a capacitive-type switching means depicted in FIG. 16 and which includes a pair of spaced-apart electrodes 92 and 93 mounted on the circuit card 219 on flap 200 of a self-contained alert device AA′″ having many similarities to device AA of FIGS. 1 to 3 but with the switching means 24 thereof deleted. More specifically, the electrodes 92 and 93 are attached by bonding or other means to the circuit card 219 (on the aforesaid first flap 200 of the alert device) and are spaced apart along an axis generally paralled to the hinge axis thereof. Another component of the switching means is an elongated electrode 91 bonded or otherwise attached to the other flap 212 of the alert device. The electrode 91 is positioned on flap 212 so that it will be in register with the electrodes 92 and 93 when the flaps 200 and 212 are closed.

The electrodes 92 and 93 are also shown in the capacitive-type switching means signal processing circuit shown, in block diagram form, in FIG. 17 and are electrically connected to other elements in the circuit as will be discussed below. The electrode 91 is also shown in FIG. 17 to be adjacent to electrodes 92 and 93. Electrode 91 is not directly electrically connected to the circuit. However, as will be understood by those skilled in the art, the distance between the electrode 91 and the pair of co-acting electrodes 92 and 93 determines the magnitude of the effective capacitance coupling the electrode 92 to its adjacent electrode 93. Thus, if the self-contained alert device flaps are closed, then there is a maximum level of capacitance established between electrodes 92 and 93 and, as the flaps are opened and are moving away from one another, the level of capacitance will decrease. This change of the level of capacitance is used advantageously in the signal processing circuit of FIG. 17 to perform a switching function analogous to the switching function of the switching means 24 of FIGS. 1 to 3.

In FIG. 17 an oscillator 95 provides a constant signal via 95′ to electrode 92 and via 95″ to a synchronous detector 96; said constant signal may be, for example, a 16 k Hz square wave and is identified in FIG. 17 as “signal A”. The electrode 93 is connected via 93′ to a band pass filter 94; the input and output signals for which are identified as “signal B” and “signal B+” respectively. The signal “B+” is applied via 94′ to a threshold detector 95, the output signal “C” thereof being applied via 95′ to the aforesaid synchronous detector 96 which, in turn, has an output “Q” applied via 96′ to a low pass filter 97 having an output 97′ which is identified as “Logic Level A” and which may be connected to the alarm sound producer means of the alert card.

When the flaps of the self-contained alert device are closed and assuming the aforesaid 16 k Hz square wave output of oscillator 95, then:
Signal B is a 16 k Hz square wave plus environmental noise;
Signal B+ is a 16 k Hz square wave;
Signal C is a 16 k Hz square wave;
Q is a Logic 1; and
Logic Level A is a Logic 1.

However, when the flaps of the alert device are open, then:
Signal B is only environmental noise;
Signal B+ is “no signal, no noise”
Q is a Logic 0; and
Logic Level A is a Logic 0.

Thus, when the flaps open, there is a digital switching function.

Those skilled in the art of digital circuits will understand that the aforesaid operation of the apparatus shown in FIGS. 16 and 17 will perform the switching function taught for the operation of this invention. The entire circuit of FIG. 17 may conveniently be fabricated in an integrated circuit of a very small size and weight with appropriate connections to the electrodes 92 and 93. Further, those skilled in the art may use other means for utilizing the,capacitive switching means shown in FIG. 16; such other means are intended to be within the scope of this invention

Another example of switching means that may be used with this invention is the mechanical/electrical means depicted in FIGS. 19 to 21 discussed below.

Alternate Configurations of Card-Like Members

This invention also teaches additional or alternate configurations of the card-like member and recognizes that those skilled in the art may make adaptations of the configurations shown and described herein.

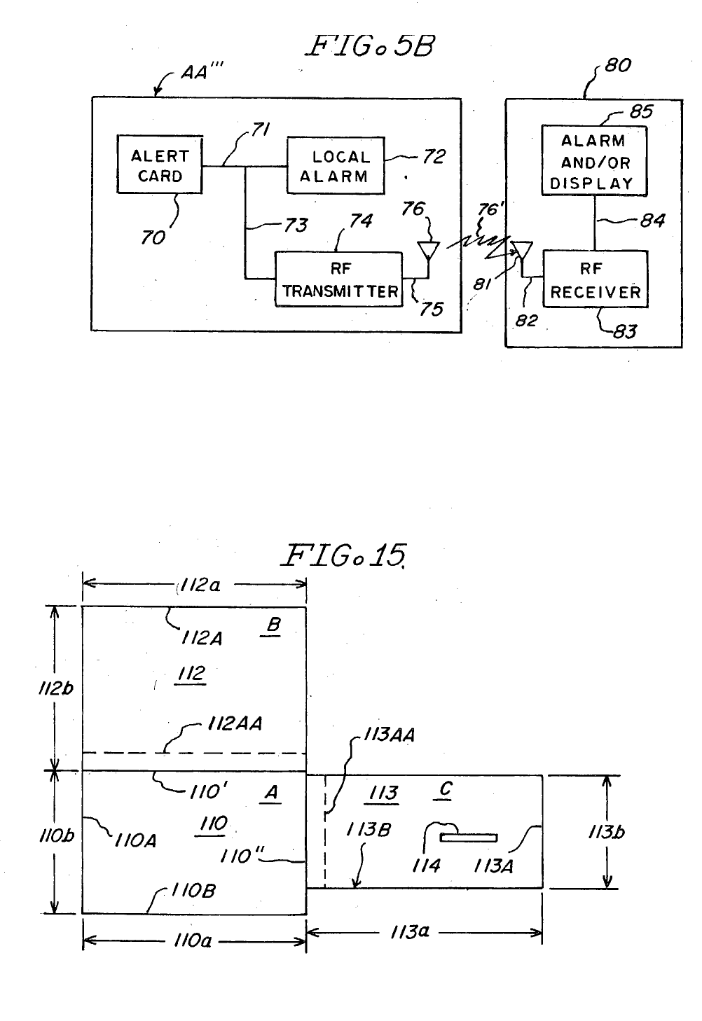

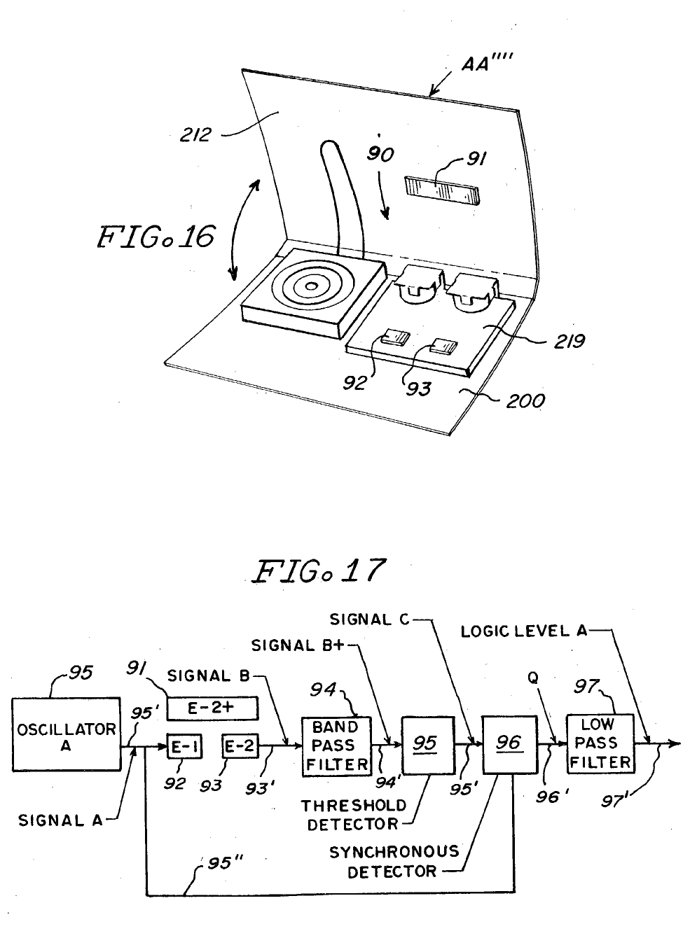

A three-flap card BB is shown in FIGS. 14 and 15 and comprises three integral flaps: 110 or the “A” flap, 112 or the “B” flap, and 113 or the “C” flap. This embodiment has the advantage of providing an additional insulative layer (the C flap) over the electronic components and means mounted on the A flap. Flaps A, B and C are preferably first defined or formed by being die cut from a single sheet of suitable paper (or equivalent) stock as shown in FIG. 15. Flap A is connected to flap B by hinge means 110′ and to flap C by hinge means 110″. It will be noted that the hinge means 110′ is substantially perpendicular to hinge means 110″. A signal emitting means 118 and a circuit card means 119 with associated switching means 124 are mounted on flap A as shown. The switching means 124 includes a raised portion 128′ corresponding in function to section 28′ of the switching means 24 for the alert card AA shown in FIGS. 1 to 3.

Regard being given to the vertical height of the elements such as signal emitting means 118 mounted on flap A, the transverse side 112b of flap B is greater in length than the length of the transverse side 110b of flap A by an amount preselected so that, when flap B is folded over onto or in abutment with the elements mounted on flap A, the longitudinal edge 112A of flap B will be in substantial register with the longitudinal edge 110B of flap A; this will facilitate the insertion of card BB into a preselected closure. In FIG. 15 the dashed line 112AA in flap B represents a possible additional fold or hinge for the folding of flap B as aforesaid. In the same context, the longitudinal length 113a of flap Cis greater in length than the longitudinal length 110a of flap A so that, when flap C is folded over onto or in abutment with flap A, the transverse edge 113A of flap C will be in substantial register with the transverse edge 110A of flap A. The dashed line 113A represents a possible additional fold or hinge for the folding of flap C as aforesaid.

The lower longitudinal edge 113B of flap C is indented in from an extension of the longitudinal edge 110B as is clearly shown in FIGS. 14 and 15. Stated otherwise, the transverse edge 113b of flap C is shorter than the transverse edge of flap A; this facilitates flap C being foldable over flap A while maintaining edge 113B thereof spaced away from edge 110B of flap A. Flap C includes a slot 114 adapted to be in register with and to permit the easy passage therethrough of element 124′ of the switching means 124 when flap C is folded onto and in abutment with flap A.

Referring to FIG. 14, the alert card BB flap C is first folded over so as to be onto and in abutment with flap A as indicated by the directional arrow 113′. At this point, the raised portion 128′ of the switching means 124 projects through the slot 114 and beyond or above the top of flap C; at this point the switching means 124 would be “closed”, i.e., functioning to provide a complete circuit between the battery means (not shown) and the signal emitting means. Next, flap B is folded, over so as to be onto and in abutment with flap C; this causes the surface of flap B in view in FIG. 14 to contact and then move the raised portion 128′ of the switching means 124 to an “open” position; this is the position of the switching means during the time that the alert card is in a closure with the closure maintaining the abutment of flap B against flap A.

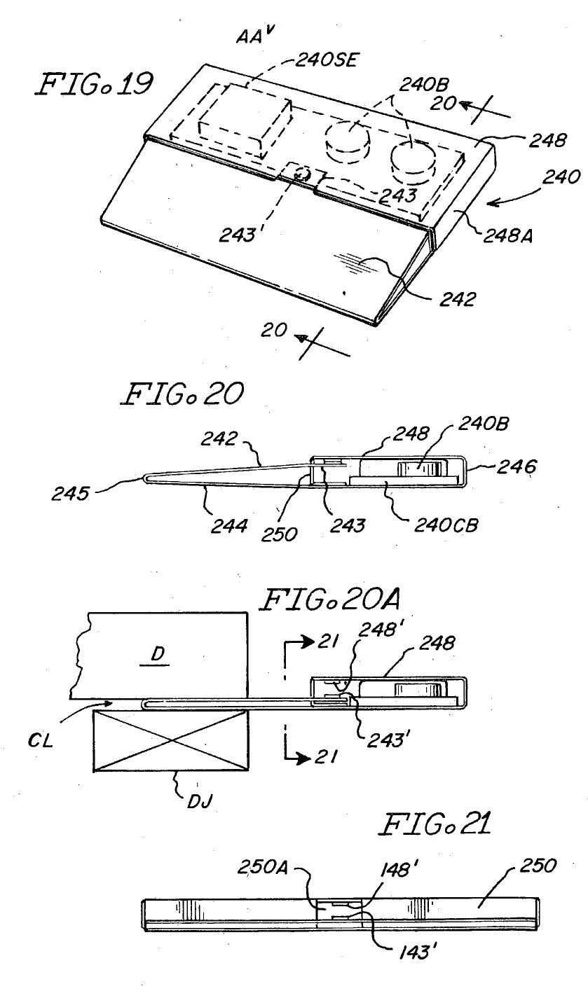

Another embodiment of an alert card device is shown in FIGS. 19 to 21. This embodiment is generally designated AA-v and may be fabricated from a single elongated sheet of suitable material such as laminated paper stock having a plurality of bends which facilitate the alert card to fold back on itself to form a box-like enclosure for the key components of the device. A first flat section 242 has a central tab 243 extending therefrom, the tab 243 carrying an electrical contact means 243′. The flat section 242 is connected by a 180-degree bend 245 to a flat bottom section 244 shown best in FIG. 20. Section 244 serves as a support means for a circuit board upon which is mounted power supply means 240B and also signal emitter means 240SE. At the right end of section 244 (as shown in FIG. 20) the paper stock material is routed vertically up at 246 a sufficient distance to provide clearance for the aforesaid electrical components; then the material extends horizontally at 248 to be generally adjacent to the edge of the first section 242; at this juncture, the material bends down to form a closing-off surface 250 of the electronics compartment as is best shown in FIG. 21, a central opening 250A in surface 250 being sized to freely receive the central tab 243. Each end of the compartment is closed off; see end portion 248A in FIG. 19.

A suitable centrally located electrical contact means 248′ is suitably secured on the inner surface of the top portion 248 of the compartment and is located further to be in contact with the electrical contact means 243′ when the device is in the condition shown in FIG. 20.

The material used for this embodiment is selected to have inherent spring characteristics. An example would be the above described laminated paper stock. The desired spring function is to bias the portion 242 away from portion 244 so that, when the device is not constrained by a closure, the portion 242 will be in the position shown in FIGS. 19 and 20, i.e., with the contact 243′ in electrical contact with the contact 248′. This would be the relationship or condition of the device when not restrained by a closure and, unless disabled, the signal emitting means would be activated either locally and/or remotely. When the device is inserted into a closure such as closure CL shown defined between a door D and a doorjamb DJ shown in FIG. 20A, then the portion 242 is moved about 245 toward the portion 244 and is held in this position because of the constraint of the closure. When the portions 242 and 244 are in this position, the contacts 243′ and 248′ are separated and hence the device is silent.

Alternately, a separate spring means, not shown, could be used to provide the spring function biasing the portion 242 away from portion 244.

Audio Recording and Playback

One of the options available for the output of the signal emitter means for all of the disclosed embodiments of a self-contained alert device provided by this invention is an audible, audio voice message. The voice message may be preselected, and thus fixed, during the manufacture of the alert device.

An alternate arrangement is the apparatus shown in FIG. 18 which depicts a block diagram of an audio recording and playback system which may be used with this invention to selectively and repetitively customize the audio message issued by the signal emitter means upon the alert card being activated by its removal from a closure so that the flaps thereof are unrestrained as described in detail above.

Referring to FIG. 18, the reference 300 applies to the disclosed audio recording and playback system. A standard microphone 302 for converting audio into an electrical signal has its output connected via a high impedance amplifier 304 to a low pass filter 306, the output of which is processed by an automatic gain control means 308 and then applied to an input amplifier 310 of a block 309 which is a functional representation of sampling, storage, playback and control of the audio recording function above described. Block 309 may be the commercially available EEPROM based recording systems well known to those skilled in the art. Amplifier 310 is an operational amplifier which provides both signal gain and signal buffering of the signal from the microphone 302 to facilitate a relatively strong signal for use by the recording block, regard being given to the signal from the microphone being comparatively very small.

Block 309 further includes (1) two audio storage means 312 and 314 each of which can store an audio message of preselected length, e.g., fifteen seconds, (2) a section 316 having the EEPROM functions including, for example eight to sixteen discrete analog levels per cell as well as the clocking and logic control functions, and (3) an output amplifier 309A.

The output from amplifier 309A is applied via a low pass filter 332 and impedance matching amplifier 334 to a speaker means 336. A power supply/control bus 340 is energized by battery means 342 connected therebetween and ground G; the bus 340 in turn supplies appropriate electrical voltage to the aforementioned components as is clearly shown in FIG. 18.

Section 316 of block 309 has several inputs. A crystal-controlled oscillator 318 provides a digital reference for clocking and the like. A channel selection switch 320 has two positions and co-acts with ground G and either terminal 321 or terminal 322 which are respectively connected via leads 321A or 322A to the block 309; the horizontal (as shown) position of switch 320 thus selectively facilitating the storage of audio by either storage means 312 or 314. Additional inputs to the block 309 include “record” and “play” control signals provided respectively by record switch means 324 and play switch means 326. Switch means 324 comprises a terminal 324′ grounded and another terminal 324″ connected via 324A to block 309. Switch means 326 comprises a grounded terminal 326′ and another terminal 326″ connected via 326A to block 309. Switch means 326 may, for some applications, be linked to the opening of an alert card after removal thereof from a closure, so as to “play” a stored audio message or the like.

The apparatus depicted in FIG. 18 may be an integral component of the above-described self-contained alert devices, most of the depicted system being implemented in an integrated circuit. Thus, a means is provided for selective and repetitive, recording of customized messages for the self-contained alert device.

In summary, a number of embodiments of the invention have been disclosed; other embodiments or variations may be made by those skilled in the art without departing from the inventive concepts set forth herein. Accordingly, this invention is to be limited only by the scope of the following claims.

1. A self-contained alert device for selective insertion between two adjacent and relatively movable separable parts of a closure and automatically providing a signal when removed from between said parts of said closure, said self-contained alert device comprising:
A. a card-like member having at least two hinged flaps, said flaps being selectively foldable onto each other from an open position to a closed position;
B. spring means connected to said flaps and adapted to bias said flaps to open from said closed position to said opened position;
C. power supply means and signal emitting means mounted on said member;
D. switch means mounted on said member and characterized by being actuated when said flaps are in said open position; and
E. circuit means including said power supply means and said switch means connected to said signal-emitting means whereby said signal emitting means is activated upon said flaps being opened to said open position.

2. The alert device of claim 1 wherein said signal emitting means comprises a sound emitting device.

3. The alert device of claim 1 wherein said signal emitting means includes wireless transmitting means.

4. The alert device of claim 3 in system combination with remote wireless receiving means.

5. The system combination of claim 4 wherein said wireless transmitting means and said wireless receiving means are pre-selected to facilitate wireless communication therebetween.

6. The system combination of claim 5 wherein said wireless receiving means includes sound emitting means.

7. The system combination of claim 1 further including display means connected to said wireless receiving means.

8. The alert device of claim 4 including both local and remote sound generating means.

9. The alert device of claim 1 wherein said spring means is integral with said card-like member and said hinged flaps.

10. The alert device of claim 1 wherein said hinged flaps each have an opposite-flap facing surface and an outside-facing surface and wherein said spring means is connected to said opposite-flap facing surfaces.

11. The alert device of claim 1 wherein said hinged flaps each have an opposite-flap facing surface and an outside-facing surface and wherein said spring means is connected to said outside-facing surfaces of said hinged flaps.

12. The alert device of claim 1 wherein said signal emitting means includes customized recording means and sound emitting means.

13. The alert device of claim 1 and means for temporarily disabling said switch means so as to prevent actuation of said signal emitting means.
